(19) United States
(12) Patent Application Publication
(10) Pub. No.: US 2023/0110546 A1
(43) Pub. Date: Apr. 13, 2023

(54) DIGITAL IDENTITY NETWORK GATEWAY

(71) Applicant: The Toronto-Dominion Bank, Toronto (CA)

(72) Inventors: Milos DUNJIC, Oakville (CA); David Samuel TAX, Toronto (CA); Pranay Chander GUPTA, Toronto (CA); Christopher Mark JONES, Villanova, PA (US)

(73) Assignee: The Toronto-Dominion Bank, Toronto (CA)

(21) Appl. No.: 17/484,318

(22) Filed: Sep. 24, 2021

(51) Int. Cl. G06Q 20/02; G06Q 20/40

(52) U.S. Cl. CPC G06Q 20/027; G06Q 20/4014; G06Q 40/02

(57) ABSTRACT

Methods and systems for leveraging payment networks to distribute digital identity data are described. In an aspect, a method includes: receiving a digital identity request from a requesting computer system through a payment network, the digital identity request being embedded in a first payment message and the digital identity request including an entity identifier; and in response to receiving the digital identity request: obtaining a digital identity payload based on the entity identifier; and providing the digital identity payload to the requesting computer system in a second payment message sent through the payment network.

### TECHNICAL FIELD

The present disclosure relates to digital identity networks and, in particular, to systems and methods for providing identity data to remote computing systems over a payment network.

### BACKGROUND

Digital Identity (ID) Networks may be used to allow identity information to be shared between entities. For example, a first entity may wish to obtain identification information for a second entity, such as an individual. In order to do so, the first entity may rely upon a digital identity network. A digital identity network may be a system or a collection of systems that allow for electronic distribution or verification of identity information. By way of example, such systems may provide for electronic and remote distribution or verification of any one or more of address information, name, date of birth, a government issued identifier (such as a social insurance number, driver’s license number, etc.), credit score data, a telephone number, a messaging address such as an email address, or other identity data.

While digital identity networks are useful to allow member computer systems to remotely receive identity information, non-member systems may be excluded from such networks. For example, some digital identity networks may only allow member systems that are situated in or associated with a particular country to access identity data. Entities from another country may be excluded. Even when an entity is permitted to join a particular digital identity network they may choose not to do so because they lack technical or computing resources to do so.

Thus, there may be a desire for non-member systems to obtain digital identity data from a digital identity network.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computer device;

FIG. 3 shows a simplified organization of software components stored in a memory of the example computer device of FIG. 2;

FIG. 4 is a flowchart showing operations performed by a computer system in providing a digital identity payload using a payment message;

FIG. 5 is a flowchart showing operations performed by a computer system in obtaining a digital identity payload; and

FIG. 6 is an example notification in accordance with example embodiments.

### DETAILED DESCRIPTION OF VARIOUS EMBODIMENTS

Like reference numerals are used in the drawings to denote like elements and features.

According to an aspect there is provided a computer system. The computer system may include a processor and a communications module coupled to the processor. The computer system may include a memory module coupled to the processor and storing instructions that, when executed by the processor, cause the computer system to: receive a digital identity request from a requesting computer system through a payment network, the digital identity request being embedded in a first payment message and the digital identity request including an entity identifier; and in response to receiving the digital identity request: obtain a digital identity payload based on the entity identifier; and provide the digital identity payload to the requesting computer system in a second payment message sent through the payment network.

Conveniently, by leveraging payment networks to distribute digital identity data, existing infrastructure may be used to distribute digital identity data. Using payment networks for this purpose may limit or reduce infrastructure requirements for obtaining digital identity data. Further, since systems that are connected to payment networks may be associated with financial institutions, such systems may be highly secure and may allow digital identity data to be distributed in a highly secure manner.

In some implementations, obtaining the digital identity payload may include: obtaining digital identity data from a digital identity network using the entity identifier; and obtaining the digital identity payload based on the obtained digital identity data.

Conveniently, such systems may allow remote computer systems to access digital identity networks without requiring such systems to conform to the technical specifications of a particular digital identity network. In this way, each system that obtains digital identity data may not need to be configured to conform with a specification or protocol that is defined for the digital identity network. Rather, when a requesting system requires digital identity data and that system does not have access to the digital identity network that stores or provides such data, it may engage a gateway (which may also be referred to as an interface system or an interface computer system) by sending a message to the gateway via a payment network. The gateway may be configured to interact with the digital identity network according to the specification or protocol in order to obtain the requested data and it may provide such data to the requesting system via a payment message.

Further, in some instances, the digital identity network may be a private network and the gateway may allow trusted systems that are not part of the private network to access the gateway. By way of example, a remote computer system may obtain digital identity data even if it does not have a token or other credential that provides the computer system with access to a digital identity network that provides the identity data since the gateway uses its token or credential to obtain the digital identity data and then provides such data to the trusted remote system that requested such data.

In some implementations, the first payment message that includes the digital identity request may include category definition data defining one or more categories of digital identity data being requested. The obtained digital identity data may match the one or more categories defined by the category definition data.

In some implementations, the second payment message may include the digital identity data.

In some implementations, the second payment message may include a link to the digital identity data.

In some implementations, the digital identity request may include a requestor identifier. The requestor identifier may be provided to the digital identity network when the digital identity data is obtained from the digital identity network using the entity identifier.

In some implementations, one or both of the first payment message and the second payment message may be for a nominal value.

In some implementations, one or both of the first payment message and the second payment message may be for zero value.

In some implementations, the first payment message may be a request to transfer message. The second payment message may be a reply to the request to transfer message.

In some implementations, the digital identity payload may be a single use token allowing access to the digital identity network.

In some implementations, the digital identity payload may be included as metadata in the second payment message.

In another aspect, a method is described. The method may include: receiving a digital identity request from a requesting computer system through a payment network, the digital identity request being embedded in a first payment message and the digital identity request including an entity identifier; and in response to receiving the digital identity request: obtaining a digital identity payload based on the entity identifier; and providing the digital identity payload to the requesting computer system in a second payment message sent through the payment network.

In some implementations, obtaining a digital identity payload may include:
obtaining digital identity data from a digital identity network using the entity identifier; and
obtaining the digital identity payload based on the obtained digital identity data.

In some implementations, the first payment message may include category definition data defining one or more categories of digital identity data being requested. The obtained digital identity data may match the one or more categories defined by the category definition data.

In some implementations, the second payment message may include the digital identity data.

In some implementations, the second payment message may include a link to the digital identity data.

In some implementations, the digital identity request may include a requestor identifier. The requestor identifier may be provided to the digital identity network when the digital identity data is obtained from the digital identity network using the entity identifier.

In some implementations, one or both of the first payment message and the second payment message may be for a nominal value.

In some implementations, one or both of the first payment message and the second payment message may be for zero value.

In some implementations, the first payment message may be a request to transfer message. The second payment message may be a reply to the request to transfer message.

In some implementations, the digital identity payload may be a single use token allowing access to the digital identity network.

In some implementations, the digital identity payload may be included as metadata in the second payment message.

In another aspect, a non-transitory computer readable storage medium is described. The non-transitory computer readable storage medium may include computer-executable instructions which, when executed, configure a processor to perform a method described herein. For example, the computer-executable instructions may, when executed, configure a processor to: receive a digital identity request from a requesting computer system through a payment network, the digital identity request being embedded in a first payment message and the digital identity request including an entity identifier; and in response to receiving the digital identity request: obtain a digital identity payload based on the entity identifier; and provide the digital identity payload to the requesting computer system in a second payment message sent through the payment network.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of ...and...” is intended to cover any one or more of the listed elements, including any one of the listed elements alone, any sub-combination, or all of the elements, without necessarily excluding any additional elements, and without necessarily requiring all of the elements.

Systems and methods for providing identity data to remote computer systems using a payment network are described below.

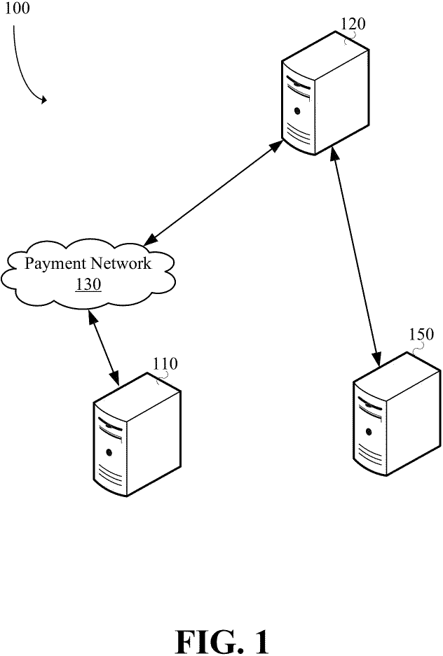

FIG. 1 is a schematic operation diagram illustrating an operating environment of an example embodiment. FIG. 1 illustrates a system 100 for obtaining identity data at a point of sale terminal.

As shown, a requesting computer system 110 is in communication with a gateway 120. The requesting computer system 110 and the gateway 120 may be coupled to and communicate with one another via a network which is, in the illustrated example, a payment network 130.

The payment network 130 may be of various types. In some implementations, the payment network 130 may be or include a transfer rail. The transfer rail may also be referred to as a payment rail. In some implementations, the payment rail may be a real time payment rail. A real time payment rail is a payment rail that allows for real time or near real time settlement of payments. Near real time is defined herein to mean settlement within one minute or less. Real time is defined herein to mean settlement within 15 seconds or less. Real time settlement allows the recipient of a transfer to have access to transferred funds immediately after they are sent. This may be contrasted with traditional payment rails which settle using a batch process, often at the end of day.

The payment network 130 may, in some implementations, include an intermediary system. The intermediary system may, for example, relay messages between systems.

In some implementations, the payment network 130 may be provided on a public network, such as the Internet. In some implementations, the payment network 130 may be provided on or include a private network.

The payment network 130 may be or include any one or more of the following payment networks: the Society of Interbank Financial Telecommunications (SWIFT) network, a payment card network such as the Visa^{™}, American Express^{™}, or MasterCard^{™} payment card networks and the Interac^{™} payment network.

The requesting computer system 110 may be a computer system that is associated with a financial institution, such as a bank. The gateway 120 may also be or include a computer system that is associated with a financial institution, such as a bank. The financial institution associated with the requesting computer system 110 may be a different financial institution than the financial institution associated with the gateway 120. In at least some implementations, the requesting computer system 110 and the gateway 120 may be in geographically disparate locations. In some instances, the requesting computer system 110 and the gateway 120 may be situated in different countries. In some implementations, the requesting computer system 110 may be associated with a financial institution in a first country and the gateway 120 may be associated with a financial institution in a second country which is different than the first country.

The requesting computer system 110 and the gateway 120 are computer systems.

While FIG. 1 illustrates a single requesting computer system 110, more than one requesting computer system 110 may connect to the payment network 130 to receive digital identity data from the gateway 120.

The gateway 120 may have access to digital identity data and may provide such digital identity data to the requesting computer system 110 in response to a request received from the requesting computer system 110 in a payment message via the payment network 130. In the example illustrated, the gateway obtains the digital identity data via a digital identity network 150.

The digital identity network 150 stores digital identity data. The digital identity network 150 is illustrated with a single block but it may be a network consisting of numerous computer systems. For example, the digital identity network may be a blockchain network which includes a number of nodes. The blockchain network is a decentralized peer-to-peer network in which nodes may maintain respective copies of an append-only ledger.

The blockchain network may be a permissioned blockchain network in which only authorized nodes are permitted to add blocks to the blockchain. For example, only verified nodes may be granted permission to write to the blockchain. The verified nodes may be trusted nodes such as nodes associated with government organizations or other trusted entities such as banks. By way of example, the verified nodes may be associated with a driver’s license bureau, a credit bureau, a government identity issuing office such as a passport office or birth registry office, or an office of another type. Given ones of these nodes may maintain identity records of various types. For example, a node associated with a passport office may maintain digital passport records, a node associated with a driver’s license bureau may maintain digital licensing records, a node associated with a credit bureau may maintain digital credit records, and a node associated with a bank may maintain digital banking records. Various verified nodes may maintain contact information records which may, for example, specify an email address, postal address, telephone number, or other type of contact information.

Accordingly, at least some verified nodes may write to the blockchain. At least some of the blocks written to the blockchain may be related to identity data. The digital identity network 150 may store identity data associated with a plurality of users. In at least some embodiments, identity data representing personal information may not be included in the blockchain. Instead, the blocks may store a private secret that is related to such digital identity data. The private secret may act as proof to the existence of the identity data and may be used to verify the authenticity of the data. For example, in at least some embodiments, the private secret may be a hash of the digital identity data such that, when the digital identity data is received from another system (i.e., a system apart from the verified node maintaining the digital identity data), it may be verified from the hash stored in a block on the blockchain. For example, in retrieving identity data from the digital identity network 150, the gateway 120 may obtain the identity data from another system and may use the data on the blockchain to verify such data.

The blockchain network may, for example, be implemented using Hyperledger Fabric, for example. It will, however, be appreciated that the blockchain network may take other forms.

The requesting computer system 110, the gateway 120 and the digital identity network 150 may be in geographically disparate locations. Put differently, the requesting computer system 110, the gateway 120 and the digital identity network 150 may be remote from one another.

The payment network 130 and/or the digital identity network may include a computer network. In some embodiments, the computer network may be an internetwork and may be formed of one or more interconnected computer networks. For example, the computer network may be or may include an Ethernet network, an asynchronous transfer mode (ATM) network, a wireless network, a telecommunications network or the like.

Operations associated with the gateway 120 will be described in greater detail below.

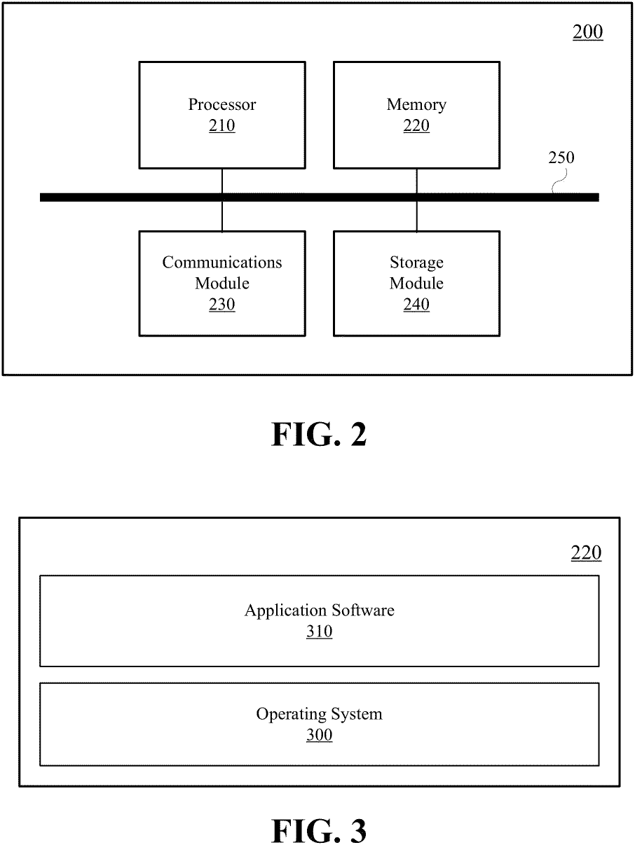

Referring now to FIG. 2, a high-level operation diagram of an example computer device 200 is shown. In some embodiments, the computer device 200 may be exemplary of the requesting computer system 110, the gateway 120 and/or the digital identity network 150 (or a portion thereof, such as a node of the digital identity network 150).

The example computer device 200 includes a variety of modules. For example, as illustrated, the example computer device 200 may include a processor 210, a memory 220, a communications module 230, and/or a storage module 240. As illustrated, the foregoing example modules of the example computer device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 200.

The communications module 230 allows the example computer device 200 to communicate with other computer or computing devices and/or various communications networks. For example, the communications module 230 may allow the example computer device 200 to send or receive communications signals. Communications signals may be sent or received according to one or more protocols or according to one or more standards. For example, the communications module 230 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the example computer device 200 to communicate using near-field communication (NFC), via Wi-Fi (TM), using Bluetooth (TM) or via some combination of one or more networks or protocols. In some embodiments, all or a portion of the communications module 230 may be integrated into a component of the example computer device 200. For example, the communications module may be integrated into a communications chipset. In some embodiments, the communications module 230 may be omitted such as, for example, if sending and receiving communications is not required in a particular application.

The storage module 240 allows the example computer device 200 to store and retrieve data. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer device 200 (FIG. 2). As illustrated, these software components include an operating system 300 and an application 310.

The operating system 300 is software. The operating system 300 allows the application 310 to access the processor 210 (FIG. 2), the memory 220, and the communications module 230 of the example computer device 200 (FIG. 2). The operating system 300 may be, for example, Google (TM) Android (TM), Apple (TM) iOS (TM), UNIX (TM), Linux (TM), Microsoft (TM) Windows (TM), Apple OSX (TM) or the like.

The application 310 adapts the example computer device 200, in combination with the operating system 300, to operate as a device performing a particular function. For example, the application 310 may cooperate with the operating system 300 to adapt a suitable embodiment of the example computer device 200 to operate as the requesting computer system 110 (FIG. 1), the gateway 120 (FIG. 1) and/or the digital identity network 150 (or a portion thereof, such as a node of the digital identity network 150).

While a single application 310 is illustrated in FIG. 2, in operation the memory 220 may include more than one application 310 and different applications 310 may perform different operations.

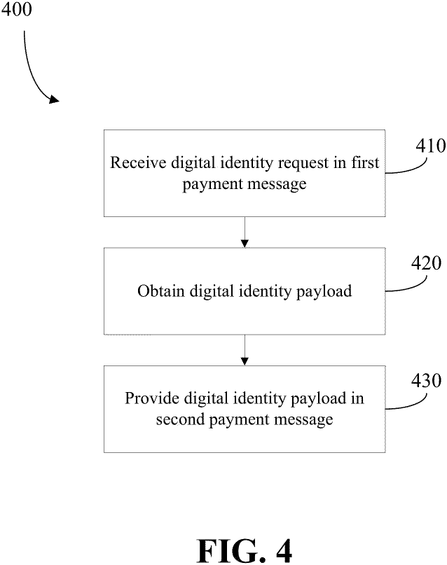

FIG. 4 is a flowchart showing operations performed by a computer system, such as the gateway 120. The operations may be included in a method 400 which may be performed by the gateway 120. For example, computer-executable instructions stored in memory of the gateway 120 may, when executed by the processor of the gateway 120, configure the gateway 120 to perform the method 400 or a portion thereof.

At operation 410, the method 400 includes receiving a digital identity request. The digital identity request may be received at the gateway 120 from a requesting computer system 110. The digital identity request is an electronic message. The digital identity request may be received through a payment network 130. For example, the digital identity request may be embedded in a payment message, which may be referred to as a first payment message.

In at least some implementations, the payment message may be for a nominal value. That is, the payment message may represent a transfer for a nominal amount of resources, such as for nominal funds. Nominal, as used herein, may mean one dollar or less. For example, a nominal transfer may be for one United States dollar, one cent, etc. In some instances, the payment network may support zero value payment messages and the payment message may be for zero value. That is, a field of the payment message that specifies an amount that is being transferred by the payment message is set to zero.

In some implementations, the payment message that is received at operation 410 may be a request to transfer message. A request to transfer may be a specially formatted message that is sent from a first database management system, such as the requesting computer system 110, to a second database management system, such as the gateway 120. A request to transfer is a message that is sent on behalf of a recipient to initiate a transfer from a sender to the recipient. That is, the request to transfer is sent, on behalf of the recipient, from the requesting computer system 110 to the gateway 120, which may be associated with a sender. The request to transfer requests a transfer from a record in the database that is associated with the sender to a record in the database that is associated with the recipient.

The first payment message that includes the digital identity request may be sent from the requesting computer system after a command is received at the requesting computer system. The command may be, for example, an account-linking command. In at least some implementations, the payment message may be sent based on inputted data received at the requesting computer system from a client device. For example, the requesting computer system may receive routing data, such as an identifier for the gateway 120 and, in some instances, an account number associated with an account at the gateway 120 and the requesting computer system may use such data to identify the gateway 120 to which the digital identity request is to be routed. In another example, the requesting computer system may receive other input, such as a country of origin for a customer and may use that information in order to select an appropriate gateway 120 to receive the digital identity request. For example, the requesting computer system may have access to a routing table that maps certain information, such as a country of origin, to a particular gateway and this routing table may be used by the requesting computer system to select the gateway. In this way, different countries may be associated with different gateways and the requesting institution may identify the appropriate gateway based on the country. An example of how such a system may be useful may be as follows. When a customer of a financial institution relocates to a new country and opens an account at a new financial institution in the new country or applies for a new product or service in the new country, the customer may effectively port over digital identity data to the new financial institution or product or service provider. They may do so by identifying their past country and this may be used, together with the routing table, by the requesting computer system in order to identify the gateway to which the request for digital identity data is to be routed.

The digital identity request may include one or more parameters that define the nature of the digital identity data being requested. For example, the one or more parameters may be or include an entity identifier. The entity identifier identifies the entity for which digital identity data is being requested. By way of example, the entity identifier may include a name. Additionally or alternatively, the entity identifier may include other identification data such as, for example, a telephone number, an email address or other messaging address, a mailing address, a date of birth, a government issued identifier such as a driver’s license or social insurance number, etc. The entity identifier may be one or more identifiers that are sufficiently unique to uniquely identify appropriate digital identity data. For example, the entity identifier may, in some instances, uniquely identify the entity within the digital identity network 150.

The one or more parameters that are included in the digital identity request may, additionally or alternatively, include category definition data. The category definition data may define one or more categories of digital identity data being requested. The categories may, for example, be data types. By way of example, the categories may include one or more of: physical attribute data (such as one or more of a height, weight, hair color, eye color, etc.), a government identifier data (such as one or more of a driver’s license number, social insurance number, income tax account number, business number, social security number, etc.), credit data (such as a credit rating), date of birth information (such as a year of birth, month of birth and/or date of birth, and/or age), address information (such as a mailing and/or residential address), contact data (such as a telephone number, email address, instant messaging address, etc.), biometric authentication data, such as a fingerprint profile, etc.

The categories may have a greater or lesser level of specificity than the categories defined above. For example, rather than having a physical attribute data category, there may be categories for each specific physical attribute that may be sought. Further, other categories may be used instead of or in addition to those recited above.

The category definition data may be specified by the requesting computer system 110. For example, the requesting computer system 110 may specify the category definition data such that only data that is required by the requesting computer system is obtained.

The one or more parameters may, additionally or alternatively, include a requestor identifier. The requestor identifier may be an identifier that uniquely identifies the requesting computer system 110.

The digital identity request may be included as metadata in the first payment message. In some implementations, the first payment message may be an ISO20022 formatted payment message.

In response to receiving the digital identity request, the gateway 120 performs a number of operations. For example, in response to receiving the digital identity request, the gateway 120 obtains a digital identity payload. The digital identity payload may be obtained based on the entity identifier.

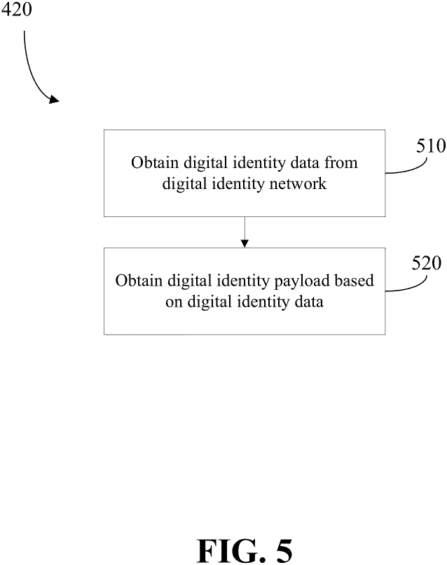

Reference will now be made to FIG. 5 which shows example operations that may be performed by the gateway 120 in order to obtain the digital identity payload. For example, at an operation 510, the gateway 120 may obtain the digital identity data from a digital identity network. The gateway 120 may obtain the digital identity data from the digital identity network 150 using the entity identifier. For example, in some instances, the gateway 120 may submit a request for digital identity data to the digital identity network 150. The request for digital identity data is not a payment message. Rather, the request for digital identity data is an electronic message that is formatted according to a specification defined for the digital identity network 150.

The request for digital identity data that is sent from the gateway 120 to the digital identity network 150 may include an entity identifier which may be or may be based on the entity identifier received in the digital identity request at the operation 410. The request for digital identity data may also include category definition data. The category definition data may be or may be based on the category definition data included in the first payment message (i.e., the message received at the gateway at operation 410). The request for digital identity data may, additionally or alternatively, include a requestor identifier which may be or may be based on the requestor identifier received in the digital identity request at the operation 410. In this way, the requestor identifier that identifies the requesting computer system 110 may be provided to the digital identity network when the digital identity data is obtained from the digital identity network.

In some implementations, the request for digital identity data that is sent from the gateway 120 to the digital identity network 150 may be received by numerous nodes that are associated with the digital identity network 150. One or more of these nodes may evaluate the request against their own records to determine whether the records contain the requested data. If a particular node has access to the requested data, that node may assume the role of a digital identity provider and may provide the requested data to the gateway 120. Accordingly, at the operation 510, the gateway may obtain the digital identity data. Then, at an operation 520, the gateway 120 may obtain the digital identity payload based on the obtained digital identity data. The digital identity payload may include the digital identity data. The digital identity payload may, however, be reformatted to be compliant with a specification defined for the payment network 130.

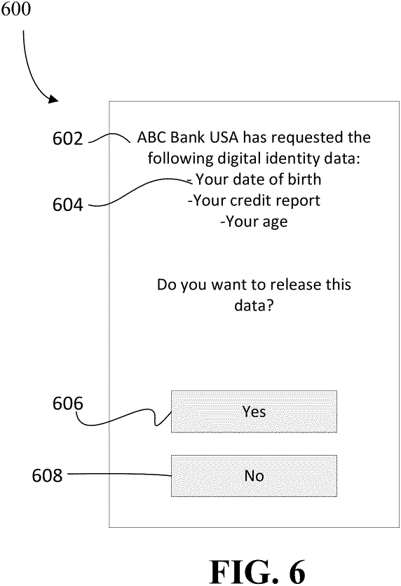

In some implementations, the node that assumes the role of the digital identity provider may only provide digital identity data if authorization data is received from a client device associated with a record or account that includes the requested data. For example, the digital identity provider or a facilitation system associated with the digital identity network may send a notification to the client device that is associated with that record or account. An example notification 600 is illustrated in FIG. 6. As illustrated, the notification 600 may include a requestor identifier 602. The requestor identifier may identify one or both of the requesting computer system 110 and the gateway 120. The notification 600 may also include an indication 604 of the category or type of digital identity information that is requested. The notification 600 may also include one or more interface elements 606, 608 for inputting an instruction or command to enable or disable the sending of digital identity data. For example, the notification 600 of FIG. 6 includes a first selectable interface element 606 for inputting an instruction to enable the sending of digital identity data and a second selectable interface element 608 for inputting an instruction to disable the sending of the digital identity data. The digital identity provider may only provide the digital identity data to the gateway if an instruction to enable the sending of such data is received from the client device.

The digital identity data that is obtained from the digital identity network at the operation 510 is digital identity data that matches one or more parameters contained in the digital identity request received at the operation 410. For example, the digital identity data may be data that matches the one or more categories defined by the category definition data.

The digital identity payload that is obtained at the operation 420 may be or include the digital identity data. Additionally or alternatively, the digital identity payload may include a link to digital identity data or other access information that may allow for the retrieval of the digital identity data from a server. For example, the link may be a link to a server, such as a web server which hosts the digital identity data. The digital identity data may, in some instances be hosted on the web server or otherwise provided to the requesting computer system 110 in an encrypted format so that it is readable only to the requesting computer system 110. In some instances, the encryption may rely on an encryption key that was provided by the requesting computer system 110 in the digital identity request. For example, the encryption key may be a public key for the requesting computer system 110. Accordingly, obtaining the digital identity payload at operation 420 may include encrypting the digital identity payload and the encryption may be performed based on an encryption key included in the digital identity request received at the operation 410.

In response to receiving the digital identity request and, after obtaining the digital identity payload at the operation 420, the gateway 120 may provide the digital identity payload to the requesting computer system 110 at operation 430. The digital identity payload may be provided to the requesting computer system 110 in a second payment message. The second payment message may be sent through the payment network 130.

In at least some implementations, the second payment message includes the digital identity data. The digital identity data may be included, for example, as metadata in the second payment message. In some implementations, the second payment message may be an ISO20022 formatted message. In another implementation, the second payment message may include a link or other access information to the digital identity data. For example, the link may be a link to a web server.

The second payment message that is used to provide the digital identity payload to the requesting computer system 110 may be for zero or nominal value. In some implementations, the second payment message may be for an offsetting amount with respect to the first payment message. That is, the first payment message and the second payment messages may effect a transfer back-and-forth of the same amount so that no net funds are exchanged.

As noted above, in some implementations, the first payment message that is received at operation 410 may be a request to transfer message and the second payment message that is sent at operation 430 may be a reply to the request to transfer message. For example, the first payment message may request the transfer of a defined amount of funds and the second payment message which acts as a reply to the first payment message may effect the transfer of the defined amount of funds.

Other techniques of providing digital identity data and/or a digital identity payload may be used in other implementations. For example, in some instances, the techniques described above in which the gateway 120 accesses the digital identity network 150 may be modified. For example, in some instances, operation 420 of the method 400 may include obtaining a single use token which allows one-time access to the digital identity network. This token may be included in the second payment message as the digital identity payload to allow the requesting computer system 110 to access the digital identity network 150 to directly retrieve digital identity data.

The receiving computer system 110 may use the received digital identity payload in a variety of ways. For example, in some implementations, the received digital identity payload may be used to initiate an authenticated session with a client device. In another example, the digital identity payload may be used to configure a profile for an account at the requesting computer system. In another example, the digital identity payload may be used to enable a digital features at the requesting computer system for an account. Other uses may be made of the digital identity payload apart from those listed above.

The methods described above may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a processor;
a communications module coupled to the processor; and
a memory module coupled to the processor and storing instructions that, when executed by the processor, cause the computer system to:
receive a digital identity request from a requesting computer system through a payment network, the digital identity request being embedded in a first payment message and the digital identity request including an entity identifier; and
in response to receiving the digital identity request:
obtain a digital identity payload based on the entity identifier; and
provide the digital identity payload to the requesting computer system in a second payment message sent through the payment network,
wherein the first payment message and the second payment message are for offsetting non-zero amounts such that no net transfer occurs by operation of both of the first payment message and the second payment message.

2. The computer system of claim 1, wherein obtaining a digital identity payload includes:
obtaining digital identity data from a digital identity network using the entity identifier; and
obtaining the digital identity payload based on the obtained digital identity data.

3. The computer system of claim 2, wherein the first payment message includes category definition data defining one or more categories of digital identity data being requested and the obtained digital identity data matches the one or more categories defined by the category definition data.

4. The computer system of claim 2, wherein the second payment message includes the digital identity data.

5. The computer system of claim 2, wherein the second payment message includes a link to the digital identity data.

6. The computer system of claim 2, wherein the digital identity request includes a requestor identifier and wherein the requestor identifier is provided to the digital identity network when the digital identity data is obtained from the digital identity network using the entity identifier.

7. (canceled)

8. (canceled)

9. The computer system of claim 1, wherein the first payment message is a request to transfer message and the second payment message is a reply to the request to transfer message.

10. The computer system of claim 1, wherein the digital identity payload is a single use token allowing access to the digital identity network.

11. The computer system of claim 1, wherein the digital identity payload is included as metadata in the second payment message.

12. A method comprising:
receiving a digital identity request from a requesting computer system through a payment network, the digital identity request being embedded in a first payment message and the digital identity request including an entity identifier; and
in response to receiving the digital identity request:
obtaining a digital identity payload based on the entity identifier; and
providing the digital identity payload to the requesting computer system in a second payment message sent through the payment network,
wherein the first payment message and the second payment message are for offsetting non-zero amounts such that no net transfer occurs by operation of both of the first payment message and the second payment message.

13. The method of claim 12, wherein obtaining a digital identity payload includes:
obtaining digital identity data from a digital identity network using the entity identifier; and
obtaining the digital identity payload based on the obtained digital identity data.

14. The method of claim 13, wherein the first payment message includes category definition data defining one or more categories of digital identity data being requested and the obtained digital identity data matches the one or more categories defined by the category definition data.

15. The method of claim 13, wherein the second payment message includes the digital identity data.

16. The method of claim 13, wherein the second payment message includes a link to the digital identity data.

17. The method of claim 13, wherein the digital identity request includes a requestor identifier and wherein the requestor identifier is provided to the digital identity network when the digital identity data is obtained from the digital identity network using the entity identifier.

18. (canceled)

19. (canceled)

20. A non-transitory computer readable storage medium comprising computer-executable instructions which, when executed, configure a processor to:
receive a digital identity request from a requesting computer system through a payment network, the digital identity request being embedded in a first payment message and the digital identity request including an entity identifier; and
in response to receiving the digital identity request:
obtain a digital identity payload based on the entity identifier; and
provide the digital identity payload to the requesting computer system in a second payment message sent through the payment network,
wherein the first payment message and the second payment message are for offsetting non-zero amounts such that no net transfer occurs by operation of both of the first payment message and the second payment message.
